(19) United States
(12) Patent Application Publication
(10) Pub. No.: US 2004/0006164 A1
(43) Pub. Date: Jan. 8, 2004

(54) Intumescent fire retardant polymeric composition

(76) Inventor: Ismat A. Abu-Isa, Rochester Hills, MI (US)

Correspondence Address: VINCENT A. CICHOSZ, DELPHI TECHNOLOGIES, INC., P.O. Box 5052, Mail Code: 480-410-202, Troy, MI, 48007-5052, US

(21) Appl. No.: 10/323,497

(22) Filed: Dec. 18, 2002

Related U.S. Application Data
(60) Provisional application No. 60/351,062, filed on Jan. 23, 2002.

(51) Int. Cl. C08K 5/36; C08K 3/10; C08J 3/00; C08K 5/13; C08K 5/10; C08K 5/09; C08K 5/12; C08L 1/00; C08K 5/48

(52) U.S. Cl. 524/283; 524/409; 524/291

(57) ABSTRACT

An intumescent fire retardant polymeric composition includes a thermoplastic polymer and an intumescent and fire-resistant additive for the thermoplastic polymer having less than fifty percent by weight of a total weight of the composition.

### CROSS-REFERENCE TO RELATED APPLICATION(S)

The present invention claims the priority date of copending U.S. Provisional Patent Application Ser. No. 60/351,062, filed Jan. 23, 2002.

### TECHNICAL FIELD

The present invention relates generally to fuel tanks for vehicles and, more particularly, to an intumescent fire retardant polymeric composition for molding a fuel tank for a vehicle.

### BACKGROUND OF THE INVENTION

It is known to provide intumescent materials for use on wall surfaces of buildings, ships, or other structures or vessels intended for human occupancy and which are susceptible to fires. Intumescent materials contain ingredients, which decompose on severe heating to generate gases and form an incombustible or low combustible residue. The expelled gases expand the residue to form a foam layer with improved thermal insulation properties. Most commercial intumescent materials are sold in the form of paint, slurry or paste, or in form of solid resin that contains large quantities of filler and fire retardant additives, normally over sixty percent (60%).

It is also known to provide moldable intumescent materials. An example of a moldable intumescent material is a moldable intumescent polyethylene and chlorinated polyethylene composition, which is disclosed in U.S. Pat. No. 5,834,535 to Abu-Isa et al., the disclosure of which is hereby incorporated by reference. In this patent, an intumescent thermoplastic elastomer molding composition includes high density polyethylene with chlorinated polyethylene and/or silicone rubber, a heat stabilizer for the elastomer material, and an intumescent and fire-resistant additive for the thermoplastic elastomer.

However, there is concern that the above moldable intumescent material has a lower polymer content and includes ingredients that decompose at relatively lower processing temperatures. In addition, there is a concern that if the intumescent material is used for a fuel tank that the fuel tank will not have the desired mechanical properties, since higher concentration of fillers in a plastic generally results in lower strength and lower elongation.

Therefore, it is desirable to provide an intumescent fire retardant polymeric composition that has a higher polymer content. It is also desirable to provide an intumescent fire retardant polymeric composition that eliminates ingredients that decompose at relatively lower processing temperatures.

### SUMMARY OF THE INVENTION

It is, therefore, one object of the present invention to provide a new intumescent fire retardant polymeric composition.

It is another object of the present invention to provide an intumescent fire retardant polymeric composition that increases polymer content.

It is a further object of the present invention to provide an intumescent fire retardant polymeric composition that includes ingredients that have relatively high melting points.

To achieve the foregoing objects, the present invention is an intumescent fire retardant polymeric composition including a thermoplastic polymer and an intumescent and fire-resistant additive for the thermoplastic polymer having less than fifty percent by weight of a total weight of the composition.

One advantage of the present invention is that a new intumescent fire retardant polymeric composition is provided, which has increased polymer content. Another advantage of the present invention is that the intumescent fire retardant polymeric composition eliminates ingredients that decompose at relatively lower processing temperatures. Yet another advantage of the present invention is that the intumescent fire retardant polymeric composition allows the use of other high melting point polymers such as polypropylene and nylon. Still another advantage of the present invention is that the intumescent fire retardant polymeric composition contains less than fifty percent (50%) filler, resulting in better properties and processing characteristics for this material than other commercially available products. A further advantage of the present invention is that the intumescent fire retardant polymeric composition contains antimony oxide and water intercalated graphite that have a synergistic effect and reinforce each other's activities as fire retardant and intumescent additives. Yet a further advantage of the present invention is that the intumescent fire retardant polymeric composition contains antimony oxide and water intercalated graphite to formulate fire retardant intumescent compositions of many thermoplastic polymers including polyethylene, polypropylene, nylon, polyesters, polyurethanes and formulations to generate gas and increase char formation. Still a further advantage of the present invention is that the intumescent fire retardant polymeric composition improves tensile strength and other mechanical properties because of increased polymer content in the intumescent composition. Another advantage of the present invention is that the intumescent fire retardant polymeric composition eliminates ammonium dihydrogen phosphate, resulting in an intumescent composition that is more thermally stable. Yet another advantage of the present invention is that the intumescent fire retardant polymeric composition can be used to formulate intumescent materials based on higher melting polymers (as compared to polyethylene), such as polypropylene, nylon, polyester, polyurethanes, polystyrene, styrene-acrylonitrile copolymer, ABS (acrylonitrile-butadiene-styrene) terpolymer, and other polymers. Still another advantage of the present invention is that the intumescent fire retardant polymeric composition eliminates both ammonium dihydrogen phosphate and pentaerythritol from the formulation to expand the usage of intumescent materials. A further advantage of the present invention is that the intumescent fire retardant polymeric composition decreases the amount of fire retardant additives, resulting in lower cost.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of an apparatus for measuring an efficiency of an intumescent fire retardant polymeric composition, according to the present invention.

FIG. 2 is a table of formulations, flammability results, and mechanical properties of an intumescent fire retardant polymer composition, according to the present invention, based on polyethylene and a blend of polyethylene and polypropylene.

FIG. 3 is a table of formulations, flammability results, and mechanical properties of an intumescent fire retardant polymer composition, according to the present invention, based on a high melt viscosity blow molding grade polyethylene, medium melt viscosity extrusion grade polyethylene, and two low melt viscosity injection molding grades of polyethylene.

FIG. 4 is a table of formulations, flammability results, and mechanical properties of an intumescent fire retardant polymer composition, according to the present invention, based on polypropylene.

FIG. 5 is a table of formulations, flammability results, and mechanical properties of an intumescent fire retardant polymer composition, according to the present invention, based on formulations containing either antimony oxide or graphite separately.

FIG. 6 is a perspective view of a fuel tank incorporating the intumescent fire retardant polymeric composition, according to the present invention.

FIG. 7 is an enlarged fragmentary elevational view of the fuel tank of FIG. 6.

### DESCRIPTION OF THE PREFERRED EMBODIMENT

The present invention provides intumescent fire retardant polymeric compositions, which are thermoplastic molding compositions, that can be blow molded, injection molded, compression molded or otherwise suitably molded and shaped to a desired geometry or configuration by thermal processes.

In general, the present invention is an intumescent fire retardant polymeric composition including a thermoplastic polymer and an intumescent and fire-resistant additive having less than fifty percent by weight of a total weight of the composition.

The intumescent fire retardant polymeric composition includes a thermoplastic polymer. The thermoplastic polymer may be polyethylene, polypropylene, polyamide, polystyrene, styrene-acrylonitrile copolymer, acrylonitrile-butadiene-styrene (ABS), polyester, polyacetal, polymethyl acrylate, polyvinyl chloride, and a blend and copolymer made from these polymers. The thermoplastic polymer is present in the composition in a weight percent greater than fifty (50), preferably greater than sixty (60), of a total weight percent of the composition. It should be appreciated that many grades of the thermoplastic polymer may be used depending on the application and the method of processing.

The intumescent fire retardant polymeric composition also includes an intumescent and fire-resistant additive. The intumescent and fire-resistant additive may be antimony oxide (e.g., Fireshield (Sb₂O₃)), which imparts fire retardancy to the thermoplastic polymer and hence slows down the burning process. The intumescent and fire-resistant additive is present in the composition in a weight percent less than fifty (50), preferably less than forty (40), of a total weight percent of the composition.

The intumescent fire retardant polymeric composition further includes a graphite additive. The graphite additive is preferably a water intercalated graphite (graphite flake), which provides a synergistic effect with antimony oxide to impart fire retardancy to the thermoplastic polymer and hence slows down the burning process. The graphite additive is present in the composition in a weight percent less than fifty (50), preferably less than forty (40), of a total weight percent of the composition.

The intumescent fire retardant polymeric composition may include an elastomer. The elastomer is preferably a chlorinated polyethylene elastomer (CPE) in proportion to obtain desired physical properties in a molded part. The elastomer is present in the composition in a weight percent less than fifty (50), preferably less than forty (40), of a total weight percent of the composition. A liquid chlorowax (e.g., Paroil 145) is suitably used as a plasticizer when needed to impart flexibility at low temperatures.

The intumescent fire retardant polymeric composition may include an antioxidant. The antioxidant is preferably distearylthiodipropionate (DSTDP) and a butylated reaction product of p-cresol and dicyclopentadiene (Wingstay L). The elastomer is present in the composition in a weight percent less than fifty (50), preferably less than forty (40), of a total weight percent of the composition. In addition to such antioxidant, MgO (Magshield 98) is used in the formulation to absorb evolved HCL produced during aging of chlorinated polyethylene and thus act as an effective dehydrochlorination stabilizer.

The intumescent fire retardant polymeric composition may include other filler additives such as glass fibers, mica particles, and/or titanium oxide powder. The filler additive is present in the composition in a weight percent less than fifty (50), preferably less than forty (40), of a total weight percent of the composition. It should be appreciated that the filler additive, graphite additive, and intumescent and fire-resistant additive together are present in the composition in a weight percent less than fifty (50), preferably less than forty (40), of a total weight percent of the composition. It should also be appreciated that the filler material, in appropriate formulations, may be added beneficially to the composition.

The mixing of compositions described herein on a laboratory scale was achieved by different methods. The ingredients for each formulation of the composition were weighed and dry blended. Melt mixing and extrusion into a continuous rod was accomplished by using a Brabender extruder with a 20 mm barrel diameter. The extruder was designed to have three (3) heating zones on the barrel. These heating zones were controlled at temperatures ranging between 150° C. and 290° C. depending on the composition of the material being extruded. The rod die was heated to 260° C. or lower temperatures. The extruded rod was allowed to come to room temperature before pelletizing. Pellets were used to compression mold about 2 mm thick slabs. Samples for UL fire testing, fire shielding test, and for mechanical properties were cut from the compression molded samples.

Three other methods have been used for melt mixing samples in the laboratory. The first involved the use of a two roll heated mill. For an intumescent formulation based on polyethylene, the rolls were preheated to 65° C., and the resins plasticizer and stabilizers were shear mixed for about five minutes. During this time, the temperature rises to about 150° C. due to shearing. The rest of the ingredients were then added and allowed to mix for an additional period of about five to ten minute, depending on the how fast a uniform blend is observed. The second method for melt blending the compositions was by using a Brabender bowl, which is a small internal mixer. The cavity was heated to 120° C. before adding the resins, plasticizer, and stabilizer.

The blades inside the mixing bowl were rotated at 120 rpm and the ingredients were mixed for about 2 to 3 minutes. The temperature during this stage of mixing was not allowed to exceed 140° C. The rest of the ingredients were then added in, and thoroughly mixed. The third method of laboratory mixing employed a 2-pound Banbury internal mixer. A similar procedure to that used for the Brabender ball mixing was employed. Good mixing leading to a uniform product was observed using any of the above mixing procedures. For all these processes, higher temperatures are used when processing resins with a higher melting point than polyethylene. Uniformity of mixing is determined by two methods. The amount of filler in the matrix is determined by measuring percent ash remaining after pyrolysis. A minimum of three samples from each extruded batch are analyzed. Samples are pyrolyzed in a furnace at 800° C. for 10 minutes; the remaining ash is weighed after cooling to room temperature (see ASTM D 1278), and percent ash content is calculated. Ash content is a measure of organic filler in the sample that remains after all organics and volatiles are driven off by pyrolysis. Variation in ash content between batches should not exceed +/−3%. Processing conditions used in the lab for proper mixing of the compositions are used to guide large-scale factory mixing of the compositions. A Buss Kneader with a 70 mm or larger diameter barrel has been successfully used to produce similar formulations.

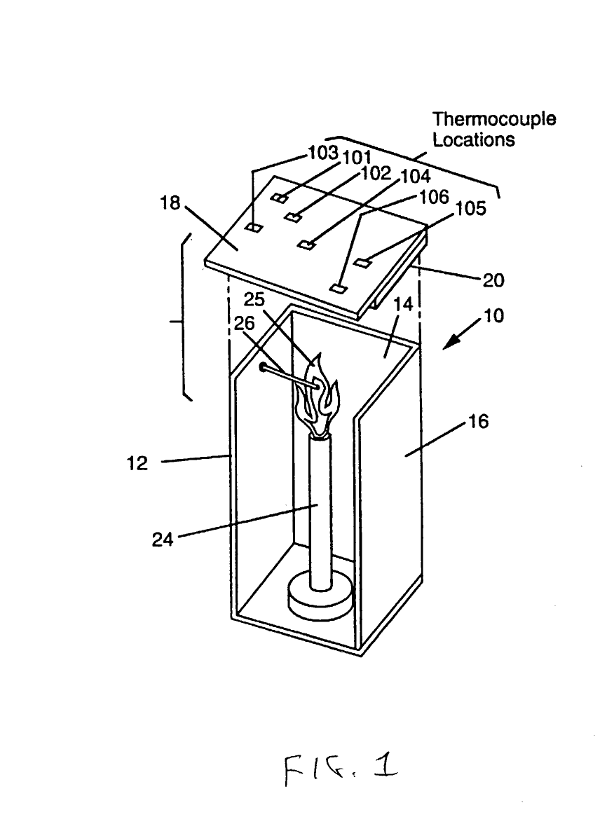

Flammability testing and mechanical properties determination were conducted on samples prepared in the lab. The main function of the intumescent fire retardant polymeric composition is in resisting the spread of flame from a fire source and shielding articles protected by the composition from high temperature rise. The characteristics or property of intumescence efficiency is measured by a procedure using an apparatus as described in connection with FIG. 1.

All of the compositions illustrated in this specification have been tested to assess the fire shielding capabilities of the intumescent fire retardant polymeric compositions, according to the present invention. The test was used to evaluate fire-shielding capabilities. It involves exposing plaques made of the intumescent fire retardant polymeric compositions, according to the present invention, to a Bunsen flame for long periods of time. Flame temperatures were in excess of 1000° C. The sample is considered to pass this test if it continues to provide fire shielding for at least thirty (30) minutes without burn through, or melt dripping. Because the shielding is not compromised, a drastic reduction in temperature on the surface of the sample opposite to the flame is achieved.

A test apparatus 10 is schematically shown in FIG. 1. The apparatus 10 included a three-wall steel chamber comprising left side wall 12, back wall 14, and right side wall 16. Each wall was a steel plate 229 mm high, 127 mm wide, and 1 mm thick. The walls were joined at their edges as illustrated in FIG. 1 to form a generally square-shaped (in cross-section) chamber with an open side or front.

A 152 mm by 152 mm by 1 mm thick steel plate adapted to be placed on top of the walls 12, 14, and 16 was employed as a roof member 18. During a test, the roof member 18 carried affixed to its lower surface a molded 127 mm by 152 mm by 2.75 mm rectangular molded slab 20 of material to be tested for intumescence effectiveness as a heat shield. It should be appreciated that the thickness of 2.75 mm of the test specimen (as well as its composition) is important to the repeatability of this test. As illustrated, the slab 20 faces downward inside of the roof member 18 and chamber during the test. On the top surface 22 of the roof member 18 were located six thermocouples leads in the locations indicated, respectively 101, 102, 103, 104, 105, and 106. It should be appreciated that test specimens with other thickness values can also be tested.

A 165 mm tall Bunsen burner 24 was used as the flame or fire source. The height of the burner 24 did not include the flame height. The flame height on top of the burner 24 was in the order of 60 mm, and it was adjusted during each test so that the tip of the inner blue cone of the flame 25, its hottest part, touched the surface of the intumescent material test specimen. A thermocouple indicated at 26 was placed at the lower surface of the slab 20 to measure the flame temperature as it impinged on the intumescent material at that point. The flame temperature as measured by the thermocouple 26 was at a location on the intumescent material opposite the location of the thermocouple 104 on the top surface 22 of the roof member 18.

While six thermocouple locations as indicated in FIG. 1 were initially used in testing of intumescence efficiency, experience has shown that equivalent useful data is obtained from using only four thermocouples at locations 101, 102, 104, and 106. It should be appreciated that differences between the flame thermocouple and the roof plate thermocouples are used as a measure of the effectiveness of intumescent material in providing thermal and fire shielding.

Aspects of the present invention will now be illustrated, without intending any limitation, by the following examples. Unless otherwise indicated, all parts and percentages are by weight.

### EXAMPLE 1

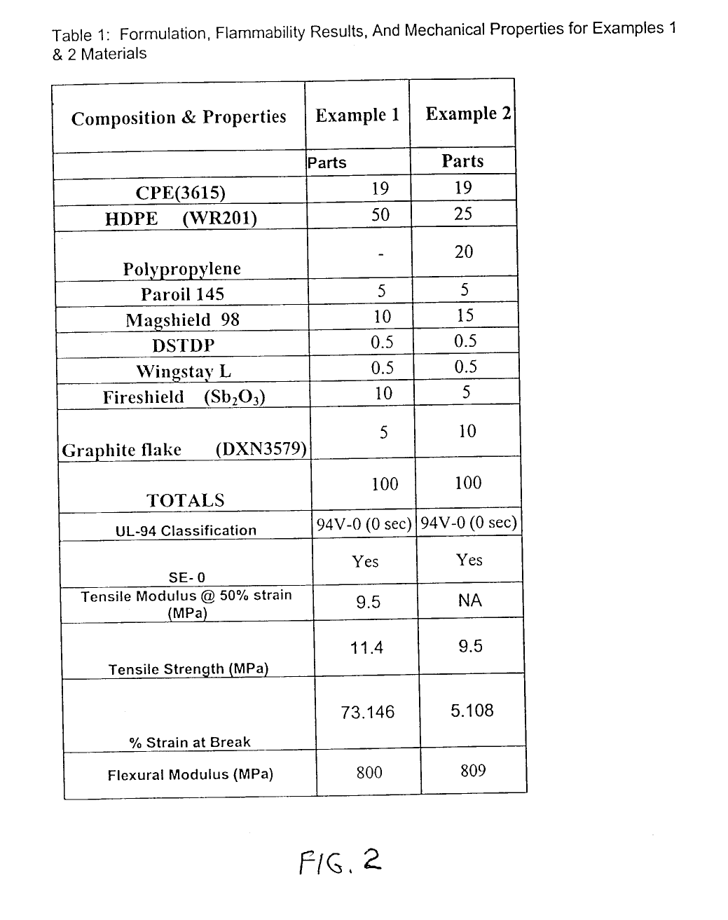

An intumescent fire retardant polymeric composition or material, according to the present invention, based on a blow-molding grade of high density polyethylene (HDPE) was formulated as seen in Table 1 of FIG. 2. The material contains both antimony oxide (Fireshield) and water intercalated graphite (DXN 3579). The total resin content of HDPE and chlorinated polyethylene (CPE) is 69%. The material also contains Paroil which is a plasticizer for CPE, two antioxidants namely distearylthiodipropionate (DSTDP) and a hindered phenol (Wingstay L), and magnesium hydroxide (Magshield). The material was tested using Underwriters Laboratory vertical flammability test UL-94. The rating was V-0 indicating that the sample self-extinguished right after removal of flame, and there was no after glow, and no melt dripping. Good mechanical properties were obtained as seen in Table 1 of FIG. 2.

### EXAMPLE 2

An intumescent fire retardant polymeric composition or material, according to the present invention, was based on a blend of HDPE, polypropylene, and CPE as seen in Table 1 of FIG. 2. The total resin content is 64%. The composition contained both antimony oxide and intercalated graphite. As seen in Table 1 of FIG. 2, this composition has UL-94 V-0 rating and good mechanical properties.

### EXAMPLES 3-6

An intumescent fire retardant polymeric composition or material, according to the present invention, was based on a high melt viscosity blow molding grade polyethylene, medium melt viscosity extrusion grade polyethylene, and two low melt viscosity injection molding grades of polyethylene. In Examples 1 and 2, the HDPE grade used was designed for blow molding and hence has a very high viscosity value. The Plastics industry uses the melt index as a measure of viscosity. The melt index is the grams of melt that passes through a capillary in ten minutes when the resin is heated to a certain temperature (e.g. 190° C., for polyethylene) and a load is applied to the melt to force it through the capillary. For very viscous materials, a high load of 21600 grams (g) is needed in order to push material through the capillary. For most plastics, processed by extrusion or injection molding, the melt index is measured using a load of only 2160 grams.

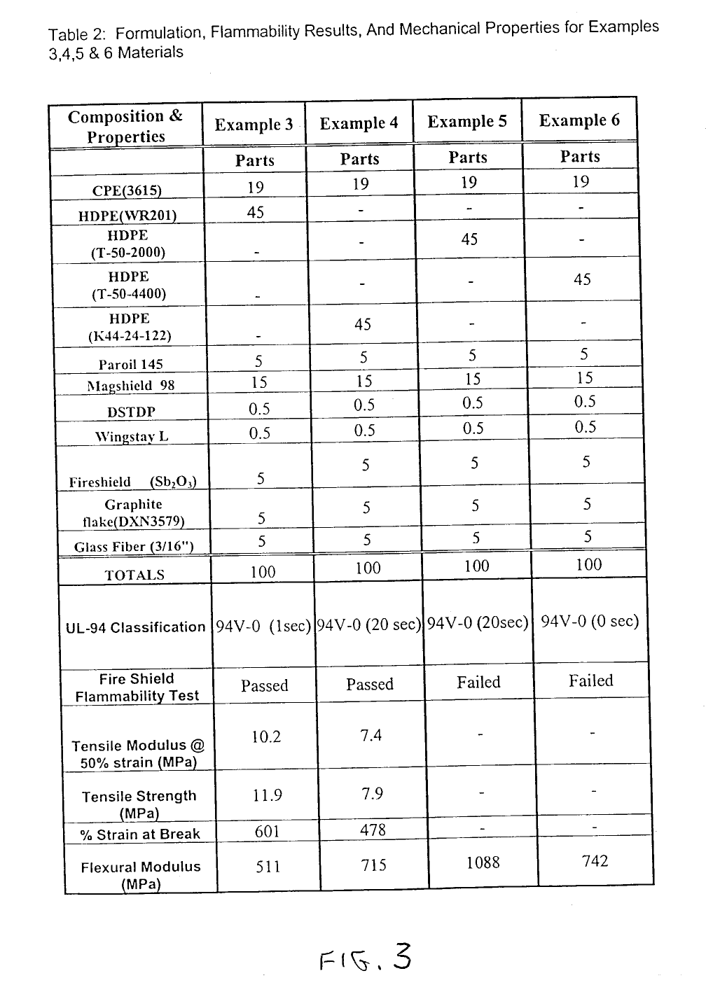

The blow molding grade used in Example 3 is WR201B, made by Atofina. It has a melt index of 8 at 190° C. and 21600 gram load. The fire retardant formulation using this polymer is shown in Table 2 of FIG. 3. As seen from Table 2 of FIG. 3, the intumescent fire retardant polymeric composition has a UL-94 fire resistance rating of V-0. It also has good tensile strength (11.93 MPa), good tensile modulus (stress at 50% elongation) of 10.2 MPa, and high ultimate elongation of 601%.

Lower melt viscosity polymers were tried using the same overall formulation. The formulation and properties of an extrusion grade polymer supplied by Solvay (K-44-24-122) are shown in Example 4 of Table 2 of FIG. 3. The melt index of the base polymer is 0.35 g/10 minutes measured at 190° C. and 2160 g. load. This polymer is much less viscous than the blow-molding grade, but more viscous than injection molding grades also shown in Table 2 of FIG. 3 under Examples 5 and 6. The UL-94 flammability rating of this composition is also V-0, and the composition has good mechanical properties.

Injection molding grades having melt indices of 20 and 45 (g/10 min) were also compounded and tested (Solvay T-50-2000 & T-50-4400). The results are shown under Examples 5 and 6 in Table 2 of FIG. 3. Both compositions were flammability tested and rated as UL-94 V-0. Hence, the intumescent fire retardant composition, according to the present invention, employing a synergistic mixture containing both antimony oxide and graphite is effective in imparting fire retardancy to different grades of high density polyethylene (HDPE) designed for different applications.

As seen from Table 2 of FIG. 3, formulations based on the two more highly viscous polymer matrices, namely the blow molding grade shown in Example 3 and the extrusion grade shown in Example 4, both pass the stringent fire shielding flammability test. Where as formulations 5 and 6 based on the less viscous injection molding grades HDPE do not pass this stringent test although they both have a UL-94 V-0 rating.

### EXAMPLE 7

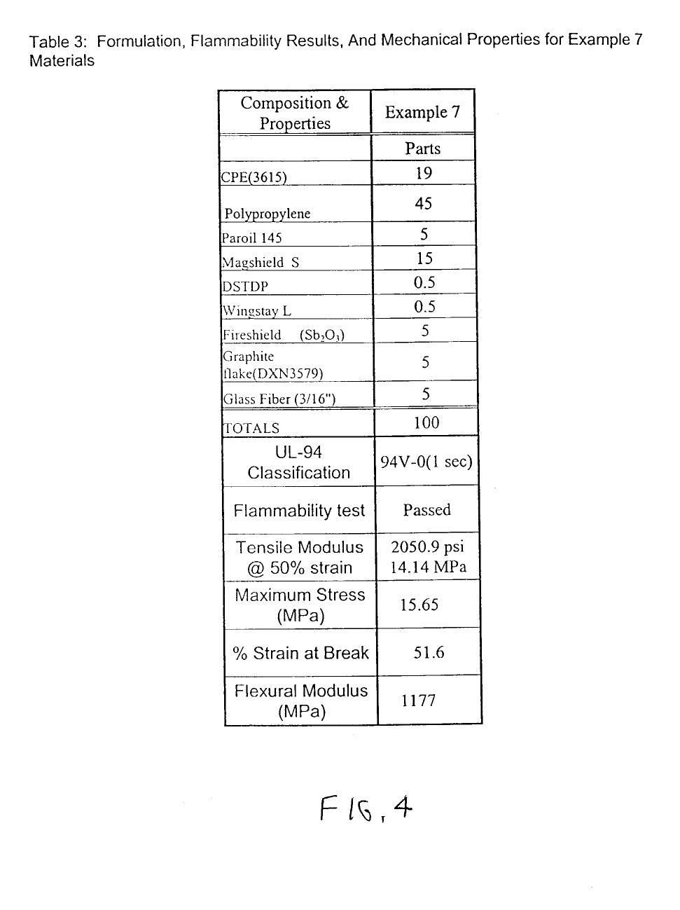

An intumescent fire retardant polymeric composition or material, according to the present invention, was based on polypropylene. In this composition, polypropylene (PP) was used instead of HDPE to make the fire retardant intumescent formulation. The grade used is a natural color high density PP having a melt index of 1.9-3.1 g/min at 230° C. and a load of 2160 g. As seen in Table 3 of FIG. 4, the formulation performs very well as an intumescent fire retardant material, having a UL rating of 94 V-0, and passing the fire shield flammability test. The composition also has good mechanical properties.

### EXAMPLES 8 & 9

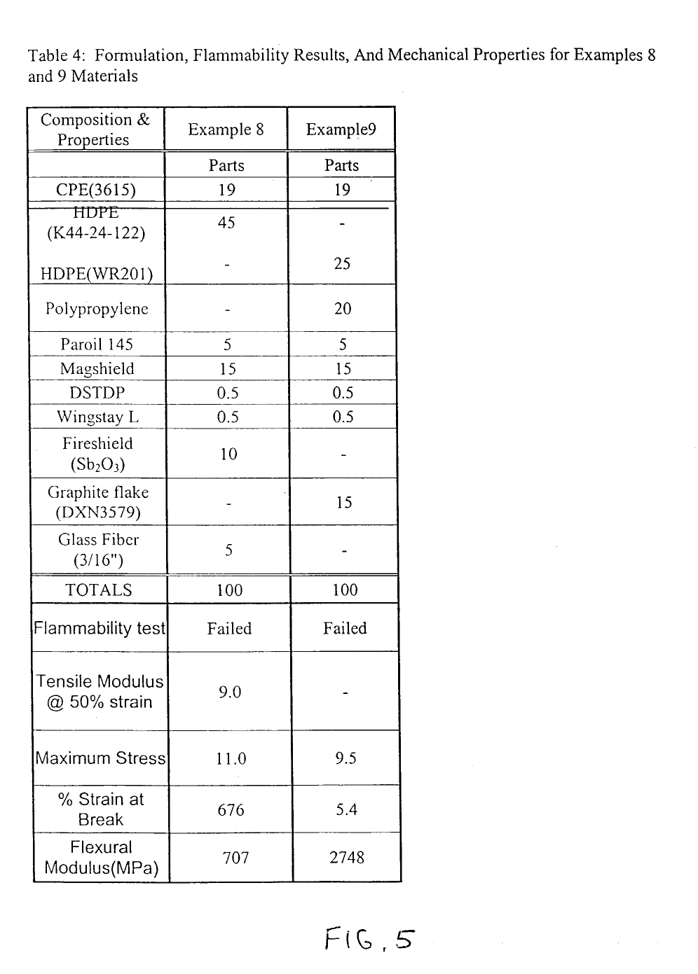

An intumescent fire retardant polymeric composition or material, according to the present invention, was based on based on formulations containing either antimony oxide or graphite separately. These examples demonstrate that both antimony oxide and water intercalated graphite are needed in order to become effective fire shields. Example 8 in FIG. 5 shows that when graphite is eliminated from the formulation, but double the amount of antimony oxide used, the material looses it effective fire shielding activity. A similar formulation where both antimony oxide and graphite were used (Example 4, Table 3) passes the fire shield flammability test. Both of the above formulations contain extrusion grade polyethylene as the base resin.

Example 9 of FIG. 5, employing polypropylene and polyethylene as the base resin, contains a high concentration of graphite (15%), but no antimony oxide. The formulation fails the fire shield flammability test as seen in Table 4 of FIG. 5. This proves that antimony oxide and water intercalated graphite are synergistic in their activity as fire retardants and are very effective when used together.

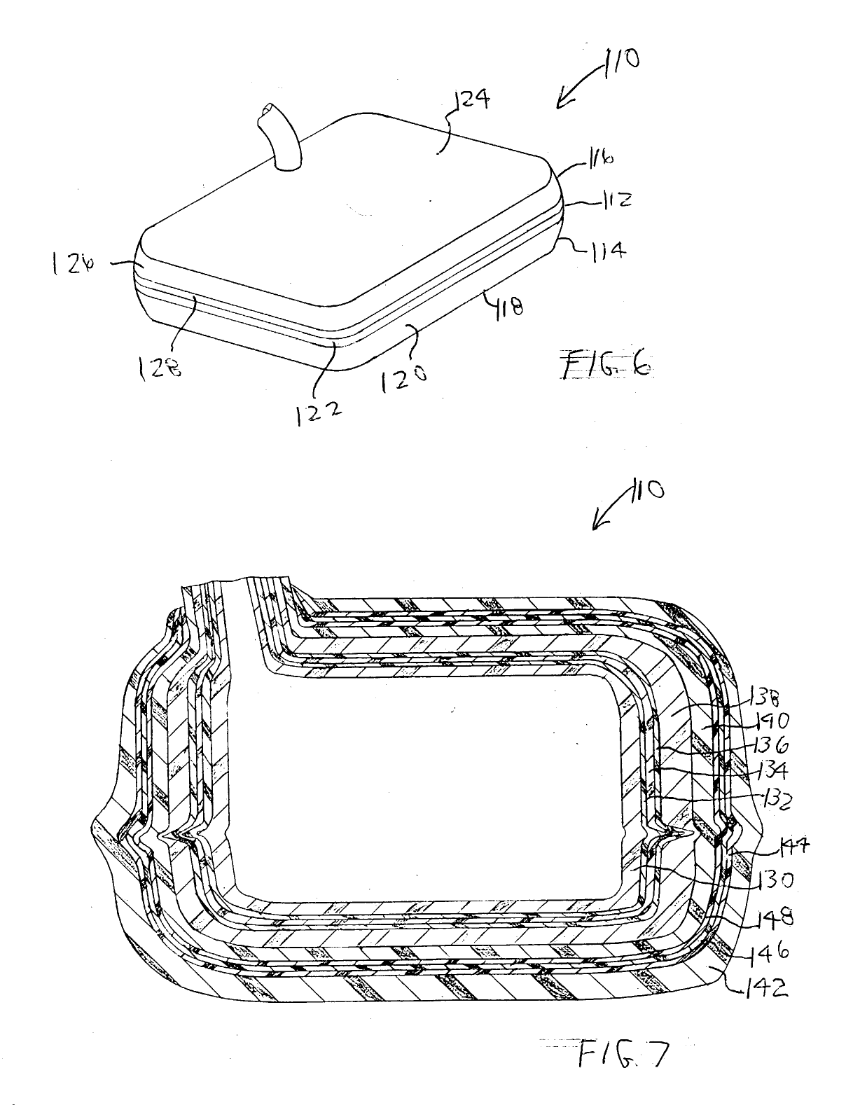

Referring to FIGS. 6 and 7, one embodiment of a fuel tank 110 incorporating the intumescent fire retardant polymeric composition, according to the present invention, is shown for a vehicle (not shown). The fuel tank 110 includes a tank shell 112. In this embodiment illustrated, the tank shell 112 is of a generally rectangular type. The tank shell 112 includes a first or lower half shell 114 and a second or upper half shell 116. The lower half shell 114 has a base wall 118 and a side wall 120 around a periphery of the base wall 118 and extending generally perpendicular thereto. The side wall 120 has a flange 122 extending outwardly and generally perpendicular thereto. The upper half shell 116 has a base wall 124 and a side wall 126 around a periphery of the base wall 124 and extending generally perpendicular thereto. The side wall 126 has a flange 128 extending outwardly and generally perpendicular thereto. The flanges 122 and 128 of the lower half shell 114 and upper half shell 116, respectively, are joined together by suitable means such as by thermoforming, compression molding, or friction welding.

Referring to FIGS. 6 and 7, the fuel tank 110 has the base walls 118, 124, side walls 120, 126, and flanges 122, 128 formed from a plurality of layers 130, 132, 134, 136, 138, 140. The first or inner layer 130 is made from a high-density polyethylene (HDPE) or similar polyolefin, which is conventional material known in the art. The first layer 130 has a predetermined thickness of approximately two millimeters (2.00 mm). The second layer 132 is a tie-layer made from an adhesive such as a maleated polyethylene (for example, ADMER Grade GT6A), which is a conventional material known in the art. The second layer 132 has a predetermined thickness of approximately 0.1 mm. The third layer 134 is a first permeation barrier layer made from a hydrocarbon barrier material such as ethylene vinyl alcohol (EVOH) copolymer, which is a conventional material known in the art. The third layer 134 has a predetermined thickness of approximately 0.11 mm. The fourth layer 136 is a tie-layer made from an adhesive such as a maleated polyethylene (for example, ADMER Grade GT6A), which is a conventional material known in the art. The fourth layer 136 has a predetermined thickness of approximately 0.1 mm. The fifth layer 138 is made from up to one hundred percent (100%) regrind of a high-density polyethylene (HDPE), which is a conventional material known in the art. The fifth layer 138 has a predetermined thickness of approximately 1.5 mm. The sixth or outer layer 140 is made from a high-density polyethylene (HDPE) or similar polyolefin, which is a conventional material known in the art. The sixth layer 140 has a predetermined thickness of approximately one millimeter (1.00 mm).

The fuel tank 110 includes a flame resistant layer 142 disposed adjacent the sixth layer 140. The flame resistant layer 142 is made from the intumescent fire retardant polymeric composition, according to the present invention. The flame resistant layer 142 has a predetermined thickness of approximately one millimeter (1.00 mm) covering the whole surface of the tank or part of the surface as needed to pass fuel tank flammability performance requirements.

In another embodiment, the fuel tank 110 may include an attachment layer 144 to attach the flame resistant layer 142 to an outer surface of a second permeation barrier layer 146 to be described. The attachment layer 144 is made from an adhesive such as a maleated polyethylene (for example, ADMER Grade GT6A), which is a conventional material known in the art. The attachment layer 144 has a predetermined thickness of approximately 0.1 mm.

The fuel tank 110 may include a second permeation barrier layer 146 with barrier properties to improve permeation resistance to alcohol or mixed alcohol-hydrocarbon type fuels. The second permeation barrier layer 146 is made from a hydrocarbon barrier material such as a fluorocarbon copolymer or ethylene vinyl alcohol (EVOH), which are conventional materials known in the art. The second permeation barrier layer 146 has a predetermined thickness of approximately 0.11 mm. The second permeation barrier layer 146 is disposed between the flame resistant layer 142 and the sixth or outer layer 140. The flame resistant layer 142 is attached to the second permeation barrier layer 146 with the attachment layer 144. The fuel tank 110 includes a second attachment layer 148 to attach the second permeation barrier layer 146 to the surface of the sixth layer 140. The second attachment layer 148 is made from an adhesive such as a maleated polyethylene (for example, ADMER Grade GT6A), which is a conventional material known in the art. The second attachment layer 148 has a predetermined thickness such as 0.1 mm. It should be appreciated that the flame resistant layer 142 increases flame resistance of the fuel tank 110. The permeation barrier layer 146 and attachment layers 144 and 148 could be applied on the whole surface of the fuel tank or just over the flange areas 122 and 128 to improve permeation resistance of this critical area where the first permeation barrier layer 134 might not be continuous.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. An intumescent fire retardant polymeric composition comprising:
a thermoplastic polymer; and
an intumescent and fire-resistant additive for the thermoplastic polymer having less than fifty percent by weight of a total weight of the composition.

2. An intumescent fire retardant polymeric composition as set forth in claim 1 wherein said thermoplastic polymer is at least one from a group comprising polyethylene, polypropylene, nylon, polyester, polyurethane, polystyrene, styrene-acrylonitrile copolymer, and acrylonitrile-butadiene-styrene terpolymer.

3. An intumescent fire retardant polymeric composition as set forth in claim 1 wherein said intumescent and fire-resistant additive includes antimony oxide.

4. An intumescent fire retardant polymeric composition as set forth in claim 1 wherein said intumescent and fire-resistant additive includes graphite.

5. An intumescent fire retardant polymeric composition as set forth in claim 1 wherein said thermoplastic polymer comprises high density polyethylene.

6. An intumescent fire retardant polymeric composition as set forth in claim 5 including chlorinated polyethylene.

7. An intumescent fire retardant polymeric composition as set forth in claim 6 including a plasticizer.

8. An intumescent fire retardant polymeric composition as set forth in claim 6 including an antioxidant.

9. An intumescent fire retardant polymeric composition as set forth in claim 8 wherein said antioxidant is at least one from a group comprising distearylthiodipropionate, hindered phenol, and magnesium hydroxide.

10. A fuel tank for a vehicle comprising:
a tank shell having a wall formed from a plurality of layers;
said layers comprising at least a first layer; and
a flame resistant layer disposed adjacent said first layer to retard flame, said flame resistant layer being made of intumescent fire retardant polymeric composition comprising a thermoplastic polymer and an intumescent and fire-resistant additive for the thermoplastic polymer having less than fifty percent by weight of a total weight of the composition.

11. A fuel tank as set forth in claim 10 wherein said thermoplastic polymer is at least one from a group comprising polyethylene, polypropylene, nylon, polyester, polyurethane, polystyrene, styrene-acrylonitrile copolymer, and acrylonitrile-butadiene-styrene terpolymer.

12. A fuel tank as set forth in claim 10 wherein said intumescent and fire-resistant additive includes antimony oxide.

13. A fuel tank as set forth in claim 10 wherein said intumescent and fire-resistant additive includes graphite.

14. A fuel tank as set forth in claim 10 wherein said thermoplastic polymer comprises high density polyethylene.

15. A fuel tank as set forth in claim 10 wherein said intumescent fire retardant polymeric composition includes chlorinated polyethylene.

16. A fuel tank as set forth in claim 10 wherein said intumescent fire retardant polymeric composition includes a plasticizer.

17. A fuel tank as set forth in claim 10 intumescent fire retardant polymeric composition includes an antioxidant.

18. A fuel tank as set forth in claim 17 wherein said antioxidant is at least one from a group comprising distearylthiodipropionate, hindered phenol, and magnesium hydroxide.

19. A fuel tank for a vehicle comprising:
a tank shell having a wall formed from a plurality of layers;
said layers comprising at least a first layer; and
a flame resistant layer disposed adjacent said first layer to retard flame, said flame resistant layer being made of intumescent fire retardant polymeric composition comprising a thermoplastic polymer, antimony oxide, and water intercalated graphite.
